(19) United States
(12) Patent Application Publication
(10) Pub. No.: US 2004/0156356 A1
(43) Pub. Date: Aug. 12, 2004

(54) Gateway

(75) Inventor: Rainer Baeder, Leinfelden (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/753,385

(22) Filed: Jan. 9, 2004

(30) Foreign Application Priority Data
Feb. 11, 2003 (EP) 03290343.7

(51) Int. Cl. H04L 12/66

(52) U.S. Cl. 370/352

(57) ABSTRACT

The object of the invention is to improve the voice quality during the transmission of voice over the Internet. A gateway is disclosed in which the packet length to be transmitted is varied as a function of the spatial distance and/or time distance of the called party from the caller. Different geographical service areas, such as local call, trunk call up to, e.g., 100 km, trunk call above 100 km, or local call, regional call, long-distance call, and/or different time ranges, e.g., time delay 30 ms, 50 ms, 100 ms, are introduced. On the assumption that local networks are less loaded than global ones, voice calls in the local area are assigned long packet lengths to optimize the bandwidth utilization and thus improve voice quality, and voice calls for long distances, where increased interference may occur on the long transmission link, are assigned short packet lengths, thereby increasing the throughput of voice data packets and thus improving voice quality.

The invention is based on a priority application EP 03290343.7 which is hereby incorporated by reference.

### BACKGROUND OF THE INVENTION

This invention relates to a gateway.

When transmitting voice over the Internet using the Voice over Internet Protocol (VoIP), a voice message of a caller is first converted, in a gateway connected to the Internet, into specific voice data packets of predetermined length, e.g., 20 ms. The voice data packets are then transmitted, by means of IP routers among other things, over the Internet to a gateway which is located closest to the called party. In this gateway, the voice data packets are converted back into speech. Under “speech”, all forms of speech outside IP are subsumed here, such as analog speech in POTS, digital speech in ISDN, DSL, PSTN, GSM, UMTS, hence all types of speech from wireline or wireless networks; POTS=Plain Old Telephone System, ISDN=Integrated Services Digital Network, DSL=Digital Subscriber Line, PSTN=Public Switched Telephone Network, GSM=Global System Mobile, UMTS=Universal Mobile Telecommunications System.

The problem arises that on transmission links which are heavily loaded, throughput is very low, which during voice transmission may lead to such a degradation that voice quality is unacceptably low or that the voice communication will be disrupted. On the other hand, on little loaded links, because of the predetermined, fixed packet length among other reasons, operational throughput is less than the theoretical maximum throughput, i.e., only medium speech quality is achieved although a better one would be possible.

The problem is solved for different services in part by the introduction of quality levels, the so-called Quality of Service (QoS). Services where a high priority is necessary and guaranteed, e.g., VoIP, are assigned a predetermined, short packet length, e.g., 30 ms. Services with medium priority, such as normal data services, are assigned a medium packet length, e.g., 60 ms. Services with low priority, such as requests for Web pages of the Internet, are assigned a long packet length, e.g., 90 ms. This only means, however, that voice data packets are switched through with preference over other data packets, whereby their throughput is increased in relation to the other data packets.

In addition, in IP routers, the throughput of data packets is optimized by sending to the gateways requests to reduce the time spacing for the transmission of data packets as long as the average throughput is below a predetermined threshold. When the threshold is exceeded, requests to increase the time spacing for the transmission of data packets are sent. This adaptive control thus relates to the time spacing of the data packets, while the packet length remains constant. Hence, the time spacing varies in accordance with the data volume and the current throughput.

### SUMMARY OF THE INVENTION

It is an object of the invention to improve the voice quality during the transmission of voice over the Internet.

This object is attained by a gateway for providing voice data packets for the transmission of voice over the Internet, wherein a module is provided which is designed to generate voice data packets of different lengths for different voice calls, the packet lengths being selected as a function of the spatial distance and/or time distance of the called party from the caller.

In the gateway according to the invention, the length of voice data packets to be transmitted is varied as a function of the spatial distance and/or time distance of the called party from the caller. Different geographical service areas, such as local call, trunk call up to, e.g., 100 km, trunk call above 100 km, or local call, regional call, long-distance call, and/or different time ranges, e.g., time delay 30 ms, 50 ms, 100 ms, are introduced. On the assumption that local networks are less loaded than global ones, voice calls in the local area are assigned long packet lengths to optimize the bandwidth utilization and thus improve voice quality, and voice calls for long distances, where increased interference may occur on the long transmission link, are assigned short packet lengths, thereby increasing the throughput of voice data packets and thus improving voice quality. Time delays of a voice data packet up to 150 ms can be compensated for by means of echo cancellers in such a way that good voice quality is obtained. If a time delay of a voice data packet from a caller to a called party is determined which is below 30 ms, packet lengths up to 120 ms can be used. If, however, a delay of 70 ms is determined, only packet lengths up to 80 ms can be used.

Further advantageous aspects of the invention are set forth in the dependent claims and will become apparent from the following description.

The invention will now be explained with the aid of several exemplary embodiments thereof.

All embodiments relate to the transmission of voice over the Internet (VoIP). A gateway serves as an interface between a non-IP network and the IP network. Two or more gateways are controlled by a gateway controller.

A gateway contains, for example, a plurality of packet switches, TDM switches, DSPs, CPUs, etc.; TDM=Time Division Multiplex. It performs protocol conversion, routing, voice processing, mapping, switching, resource management, and other functions. A gateway is also referred to as a voice gateway, trunk gateway, or media gateway, for example, and may be incorporated as a plug-in module in a DSLAM (Digital Subscriber Line Access Multiplexer).

A gateway controller, also called a softswitch, for example, contains a plurality of DSPs, CPUs, memories, etc. It performs signalling-data processing, call handling, connection handling, resource management, and other functions.

Gateway controller and gateways are interconnected. They transmit information using a specific protocol, e.g., H.248. The gateway controller communicates to the gateways connection information, i.e., information as to which input port has to be connected to which output port in order to connect a caller to the desired, called party and thus set up the voice call.

In the first embodiment, the gateway according to the invention for providing voice data packets for the transmission of voice over the Internet comprises a module which is designed to generate voice data packets of different lengths for different voice calls, the packet lengths being selected as a function of the spatial distance of the called party from the caller.

In the associated gateway controller for carrying out the signalling of voice calls and for controlling at least two gateways, a module is provided which is designed to create from the number of a called party a categorization according to the spatial distance of the called party from the caller and to transmit the information thereon to an associated gateway.

The module in the gateway is adapted to receive from the gateway controller the information about the categorization according to the spatial distance of the called party from the caller and to determine from this information an associated packet length.

Alternatively, the gateway controller comprises a module which is designed to create from the number of a called party a categorization according to the spatial distance of the called party from the caller, to determine from the categorization a predetermined packet length for voice data packets to be transmitted, and to transmit the information thereon to an associated gateway.

The appertaining method according to the invention for transmitting voice data packets over the Internet is characterized in that in at least one gateway, prior to the transmission, voice data packets of different lengths are generated for different voice calls, the packet lengths varying in accordance with the spatial distance of the called party from the caller.

Thus, in the gateway controller, first a categorization according to the spatial distance of the called party from the caller is created based on the number of the called party. To accomplish this, the number of the called party and, if necessary, the caller's number are determined from the signalling information, and on the basis of the prefix, a decision is made as to whether the call is, for instance, a local call, a regional call, or a long-distance call. If the caller and the called party have the some prefix, the call is a local call. If the prefixes differ, and the prefix of the called party begins with ++, the call is a long-distance call, with ++ specifying a country; this may be 00, for example. If the call is neither a local call nor a long-distance call, it is a regional call; this can be additionally checked by determining whether the called party's prefix begins with a +, which specifies a country; this may be the digit 0, for example.

Based on the categorization into local call, regional call, or long-distance call, different packet lengths can be assigned in the gateway or in the gateway controller. Long packet lengths are assigned for a local call, medium packet lengths for a regional call, and short packet lengths for a long-distance call.

Another example of a categorization is as follows:

Prefix of the caller: ++49 0711

Prefix of the called party:

Category 1: all prefixes ++49 0711

Category 2: all prefixes ++49 071*, ++49 071**, where*=any natural number from 0 to 9, without Category-1 prefixes

Category 3: all prefixes ++49 07**, ++49 07***, where *=any natural number from 0 to 9, without Category-2 prefixes

Category 4: all prefixes ++49 06**, ++49 06***, ++49 08*, ++49 08**, ++49 08***, where *=any natural number from 0 to 9

Category 5: all prefixes ++49 0#**, ++49 0#***, where *=any natural number from 0 to 9, and #=any natural number from 1 to 9, without Category 3 and Category 4 prefixes

Category 6: all prefixes in the EU without Germany

Category 7: all prefixes in the USA

Category 8: all international prefixes without Categories 6 and 7

Packet lengths which are assigned to Category 1 have the greatest length, e.g., 80 ms; packets lengths assigned to Category 8 have the least length, e.g., 10 ms. In the case of international calls outside the EU and the USA, it can be assumed that on the long path to the called party, there is an increased possibility that interference will occur, so that short voice data packets have a greater chance of reaching the called party undisturbed than long ones. Accordingly, voice data packets of short length are generated for such calls. If necessary, Category-1 and Category-2 calls are no VoIP calls, but VoTDM calls, where the packet length is predetermined by the time slots.

In the second embodiment, the gateway according to the invention for providing voice data packets for the transmission of voice over the Internet comprises a module which is designed to generate voice data packets of different lengths for different voice calls, the packet lengths being selected as a function of the time distance of the called party from the caller.

The gateway comprises a further module for determining the time delay of a transmission of a voice data packet from the caller to the called party. The module is designed to determine from the time delay a categorization according to the time distance of the called party from the caller and to determine an associated packet length from this information.

The determination of the time delay is made during the operation of a voice call and with real voice data. The voice call is started with short or medium packet lengths, and after receipt of information about the arrival times of the packets, the time delay is determined, a categorization is performed, and an associated packet length is selected and used for the further transmission of voice data.

Alternatively or in addition thereto, adaptive control is provided by performing a continuous on-line measurement of the time delay of voice data packets and continuously adapting the lengths of the transmitted voice data packets to the current delay. If the current delay is increased due to an increased data volume, for example, the length of the transmitted packets will be shortened. When a shorter delay is measured again, the packet length can be increased again.

In the third embodiment, a gateway is provided which differs from the gateway of the second embodiment in that the further module is designed to generate a short, medium, and a long test voice data packet, to transmit these test voice data packets to the called party and register the instants of transmission, and to receive information about the arrival times of the test voice data packets from a gateway connected to the called party in order to determine the associated time delay from the respective time difference between instant of transmission and arrival time and to determine an associated packet length from these delays.

In the case of time delays up to 150 ms for the transmission of a voice data packet from the caller to the called party, voice quality can be improved by means of echo cancellers to the point that good intelligibility is possible. If a test is made prior to the transmission of voice data to see how the current conditions on the actual connection are, an optimized packet length can be selected for each individual voice call. If the test shows that the time delay for medium and long test packets is already above 150 ms, only short voice data packets will be transmitted. If the time delay for long test packets is below 30 ms, for example, long voice data packets will be transmitted. The shorter the time delay, the longer the voice packets that will be selected. The sum of packet length and time delay is advantageously chosen to remain below 150 ms. Voice transmissions are still possible with time delays up to 400 ms but entail impairments of voice quality.

Alternatively to the determination of the time delay by storing instants of transmission, the transmitted test packets may be provided with so-called time stamps. In a test packet sent back, the instant of reception is additionally inserted as a time stamp, so that the difference of the time stamps, and consequently the time delay, is determinable directly from the received packet.

In a further variant, the time delay is determined in the gateway of the called party before the test signal is sent back, and information thereon is inserted into the test packet to be sent back or only this information is sent back to the gateway of the called party. The time delay can also be determined using the Network Time Protocol (NTP).

In all embodiments, the respective modules of the gateways may additionally be designed to reduce the lengths of the voice data packets upon receipt of a request to increase the time spacing for the transmission of voice data packets beyond a predetermined value. In the presence of an increased data volume, an IP router will request the connected gateways to transmit data packets at greater time intervals. The throughput can be increased if in addition to the transmission at greater time intervals, the packet lengths are reduced.

In all embodiments, a particularly advantageous implementation of the gateway is characterized in that the module is designed as a hardware and software module having access to at least one memory area in which a tabular arrangement of different parameter values and/or parameter ranges and associated packet lengths is stored, a parameter being a measure of the time distance and/or spatial distance of the called party from the caller.

According to a further advantageous aspect of the invention, the tabular arrangement contains a long packet duration for a short time distance and/or a short spatial distance, a medium packet duration for a medium time distance and/or a medium spatial distance, and a short packet duration for a long time distance and/or a long spatial distance.

The embodiments are limited to either a time distance or a spatial distance as the criterion for the selection of the packet length. Alternatively, a combination of embodiments is possible, so that both the spatial distance and the time distance will be taken into account in a gateway. In that case, the time distance, for example, can be selected as the preferred criterion over the spatial distance or vice versa. In a further variant, both distances are always used as the criterion, so that both must be satisfied for the selection of the packet length, i.e., the shorter one of two possible packet lengths will always be selected.

The individual embodiments can also be combined in part. For instance, the adaptive control of the current packet length (second embodiment) can also be used in the first or third embodiment.

The use of numbers in the embodiments is exemplary. Packet lengths to be used may be specified, for example, by a) n times 5 ms, n=1, 2, 3, 4, 5, . . . , or b) m times 30 ms, m=1, 2, 3, . . . , or c) o times 10 ms, o=1, 2, 3, 4, . . . It is not necessary to choose the time intervals to be equal. For example, a division is made into local calls equal to a packet length of 70 ms, regional calls equal to a packet length of 25 ms, and long-distance calls equal to a packet length of 5 ms. For one category, e.g., local calls, two or more packet lengths may be available for selection, which are then selected on the basis of the determined time delay or adapted to the current data volume during operation.

1. A gateway for providing voice data packets for the transmission of voice over the Internet, wherein a module is provided which is designed to generate voice data packets of different lengths for different voice calls, the packet lengths being selected as a function of the spatial distance and/or time distance of the called party from the caller.

2. A gateway as set forth in claim 1, wherein the module is adapted to receive, from a gateway controller, information about a categorization according to the spatial distance of the called party from the caller and to determine an associated packet length from this information.

3. A gateway as set forth in claim 1, wherein a further module is provided for determining the time delay of a transmission of a voice data packet from the caller to the called party, and that the module is designed to determine from the time delay a categorization according to the time distance and/or spatial distance of the called party from the caller and to determine an associated packet length from this information.

4. A gateway as set forth in claim 3, wherein the further module is designed to generate a short, a medium, and a long test voice data packet, to transmit these test voice data packets to the called party and register the instants of transmission, and to receive from a gateway connected to the called party information about the arrival times of the test voice data packets in order to determine from the respective time difference between instant of transmission and arrival time the associated time delay and to determine an associated packet length from these delays.

5. A gateway as set forth in claim 1, wherein the module is designed to reduce the lengths of the voice data packets upon receipt of a request to increase the time spacing for the transmission of voice data packets beyond a predetermined value.

6. A gateway as set forth in claim 1, wherein the module is designed as a hardware and software module having access to at least one memory area in which a tabular arrangement of different parameter values and/or parameter ranges and associated packet lengths is stored, a parameter being a measure of the time distance and/or spatial distance of the called party from the caller.

7. A gateway as set forth in claim 6, wherein tabular arrangement contains a long packet duration for a short time distance and/or a short spatial distance, a medium packet duration for a medium time distance and/or a medium spatial distance, and a short packet duration for a long time distance and/or a long spatial distance.

8. A gateway controller for carrying out the signalling of voice calls and for controlling at least two gateways for providing voice data packets for the transmission of voice over the Internet, wherein a module is provided which is designed to create on the basis of the number of a called party a categorization according to the time distance and/or spatial distance of the called party from the caller and to transmit the information thereon to an associated gateway.

9. A gateway controller for carrying out the signalling of voice calls and for controlling at least two gateways for providing voice data packets for the transmission of voice over the Internet, wherein a module is provided which is designed to create on the basis of the number of a called party a categorization according to the time distance and/or spatial distance of the called party from the caller, to determine from the categorization a predetermined packet length for voice data packets to be transmitted, and to transmit the information thereon to an associated gateway.

10. A method of transmitting voice data packets over the Internet, wherein at least one gateway, prior to the transmission, voice data packets of different lengths are generated for different voice calls, the packet lengths varying in accordance with the time distance and/or spatial distance of the called party from the caller.
